(19) United States
(12) Patent Application Publication
(10) Pub. No.: US 2014/0156547 A1
(43) Pub. Date: Jun. 5, 2014

(54) METHODS AND SYSTEMS FOR ASSESSING COMPUTER APPLICATIONS

(71) Applicant: THE CHILDREN'S HOSPITAL OF PHILADELPHIA, Philadelphia, PA (US)

(72) Inventors: FLAURA KOPLIN WINSTON, Narberth, PA (US); Nancy Kassam-Adams, Lovingston, VA (US); José A. B. Fortes, Gainesville, FL (US)

(73) Assignee: The Children's Hospital of Philadelphia, Philadelphia, PA (US)

(21) Appl. No.: 13/690,962

(22) Filed: Nov. 30, 2012

(51) Int. Cl. G06Q 30/00

(52) U.S. Cl. CPC G06Q 30/018
USPC 705/317

(57) ABSTRACT

Methods for assessing the effectiveness of computer applications are disclosed. Methods and systems for creating studies to assess computer applications are also disclosed. An assessable computer application may be created by storing application activities and assessment activities in a database, defining study arms for assessing a computer application, defining each study arm with a computer by receiving selections of application activities and assessment activities from the database, and storing the defined study arms as a study for assessing the effectiveness of the computer application. A computer application for achieving a goal may be assessed by defining application activities corresponding to the goal, defining at least one assessment activity corresponding to the goal, presenting the defined application activities and at least one assessment activity to study participants, collecting application interaction and assessment data, and analyzing the collected data to determine the effectiveness of the application at achieving the goal.

### STATEMENT REGARDING FEDERALLY SPONSORED RESEARCH

This invention was made, in part, with government support under grant number(s) 1127158 and 12458169 awarded by the National Science Foundation (NSF). The government has rights in aspects of this invention.

### BACKGROUND OF THE INVENTION

There is a dramatic shift underway to move many aspects of health/wellness/safety (“HWS”) promotion, training, and disease management from face-to-face encounters with clinicians and trainers to online, personalized, self-directed computer applications, often delivered via a network such as the Internet or another mode such as a cellular network. Such applications allow participants to access content at their convenience in a safe and non-threatening manner. In contrast with other HWS promotion and management approaches intended for large populations, computer applications can be structured to provide highly personalized messages based on participant data and preferences. Computer applications can enhance or replace costly face-to-face interactions in a flexible, user-friendly, and cost-effective manner, reaching populations with limited access to medical or training personnel. When based on solid evidence, computer applications can improve knowledge, skills, attitudes, behavior and health and other outcomes.

There is a need for evaluation of HWS computer applications to determine their effectiveness and other outcomes. Unfortunately, no general-purpose platform exists to conduct rigorous evaluations of computer applications for HWS or to monitor their continued use and effectiveness over time. Despite promising evidence regarding some computer applications, only a small fraction of available and widely distributed computer applications have been evaluated. In the absence of evaluation, it is impossible to know whether a computer application is effective, or might result in unanticipated negative outcomes. Evaluation also under girds optimization of computer applications—i.e., finding the most efficient combination of components (e.g., interactive features) to achieve desired outcomes or, once in production, to measure continued safety, effectiveness, efficiency and user experience over time.

A number of barriers exist to conducting rigorous evaluation: (1) technical—no general-purpose evaluation platform exists; (2) knowledge/expertise—developers of computer applications vary in their expertise in rigorous methods for evaluating efficacy/effectiveness such as those used in clinical trials; and (3) time and cost—rigorous studies require costly custom evaluation software. As such, when evaluations are conducted, many are limited to usability, consumer preference or simple knowledge studies rather than providing outcomes related to changes in behavior, health or business goals/objectives. Further challenges exist in the ability to establish and collect use and outcome metrics in a manner that allows for comparison among versions of the same application or across different applications intended to achieve a similar goal or business objective.

### SUMMARY OF THE INVENTION

Aspects of the present invention encompass methods and systems for establishing and running rigorous studies for the evaluation and on-going assessment of the effectiveness, efficiency, safety and/or usability of health, wellness or safety computer applications, conforming to clinical guidelines and regulatory requirements. The inventors have translated their considerable experience in health evaluation research into careful organization and programming elements that aid experienced and novice researchers in the design and conduct of easy, logical, well-organized and efficient studies that comply with confidentiality, privacy, and security standards.

The present invention is embodied in methods for assessing the effectiveness of computer applications and methods and systems for creating studies to assess the effectiveness of computer applications.

A study may be created by storing a plurality of application activities and assessment activities in a database, defining a number of study arms for assessing a computer application, defining each of the study arms with a computer by receiving selections of at least one application activity and at least one assessment activity from the database for each study arm, and storing the defined study arms as a study for assessing the effectiveness of the computer application.

A system for creating studies to assess the effectiveness of computer applications may include a computer executing program code to implement an assessment module for storing assessment activities, an application module for storing application activities, and a study module coupled to the assessment module and the application module that enables selection of at least one assessment activity and at least one application activity to create a study.

The effectiveness of computer applications may be assessed by defining application activities corresponding to a computer application for achieving a goal, defining assessment activities corresponding to the goal, presenting the defined application activities and at least one assessment activity to study participants for electronic interaction, collecting application interaction data from the application activities, collecting assessment data from the electronic interaction of the first group of study participants with the assessment activity at a computer, and analyzing the collected application interaction data and assessment data with the computer to determine the effectiveness of the computer application at achieving the goal.

### BRIEF DESCRIPTION OF THE DRAWINGS

The invention is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped. The letter “n” or “N” may represent a non-specific number of elements. This emphasizes that according to common practice, the various features of the drawings are not drawn to scale. On the contrary, the dimensions of the various features are arbitrarily expanded or reduced for clarity. Included in the drawings are the following figures:

FIG. 1 is a block diagram of a system for assessing effectiveness of an application in accordance with aspects of the present invention;

FIG. 2a depicts an application study development station in accordance with aspects of the present invention;

FIG. 2b depicts a data presentation and collection station for use by a study participant in accordance with aspects of the present invention;

FIG. 3 is a flowchart depicting the creation of study libraries in accordance with aspects of the present invention;

FIG. 3a is a flowchart depicting creation of an application activity library from an existing application in accordance with one aspect of the present invention;

FIG. 4 is a flow chart depicting steps for “easy study set-up” by researchers or technical and administrative support personnel, for example, in accordance with aspects of the present invention;

FIG. 4a is a flow chart depicting steps for recruitment and enrollment of study participants of FIG. 4 in accordance with aspects of the present invention;

FIG. 4b is a flow chart depicting steps for defining the study arms of FIG. 4 in accordance with aspects of the present invention;

FIG. 5 is a flowchart depicting data collection steps in accordance with aspects of the present invention;

FIG. 6 is a flow chart depicts application assessment steps in accordance with aspects of the present invention; and

FIGS. 7a, 7b, 7c, 7d, 7e, 7f, 7g, 7h, 7i, 7j are exemplary graphical user interfaces (GUIs) presented by the system of FIG. 1 for implementing the steps of FIGS. 4, 5, and 6 in accordance with aspects of the present invention.

### DETAILED DESCRIPTION OF THE INVENTION

Aspects of the present invention provide an easy-to-use, customizable, general purpose interface, functionalities, and integrated platform for primary use by those (herein called “researchers”) interested in or charged with developing, choosing, evaluating, monitoring use, benchmarking, or answering other systematic questions about computer applications (herein “applications”). Embodiments of the interface and platform provide researchers with the ability to set up and conduct studies and collect and analyze the data resulting from those studies. Such studies may involve delivering applications to users (herein called “study participants”) in accordance with rules set by the researcher to capture data and information about the study participants, about their use of the application, and about outcomes relevant to the goal of the application; and to integrate these data and allow for analyses that relate use of the application to desired outcomes (i.e., goals). This allows for general purpose customization that enables a range of study designs from simple studies, that could be facilitated through templates for study designs, to complex, adaptive study designs, for example with multiple groups of study participants receiving different applications or combinations of applications with multiple data sources and multiple data collection time points.

Embodiments of the systems and methods of the present invention provide a customizable, easy-to-use, technology-enabled software platform for engineering the targeted delivery and evaluation of self-directed health/wellness/safety (HWS) applications, e.g., online via the Internet. A goal of the inventors is for the systems and methods described herein to become the de facto standard solution for the industry, to accelerate innovation in personalized medicine and training through integration of delivery of Internet and mobile applications with evaluation/optimization of the application's ability to improve health and safety behaviors. Rigorous evaluation methodologies, behavioral and computer science are applied in exemplary embodiments to overcome cost, privacy, technological and intellectual barriers to rigorous application evaluations.

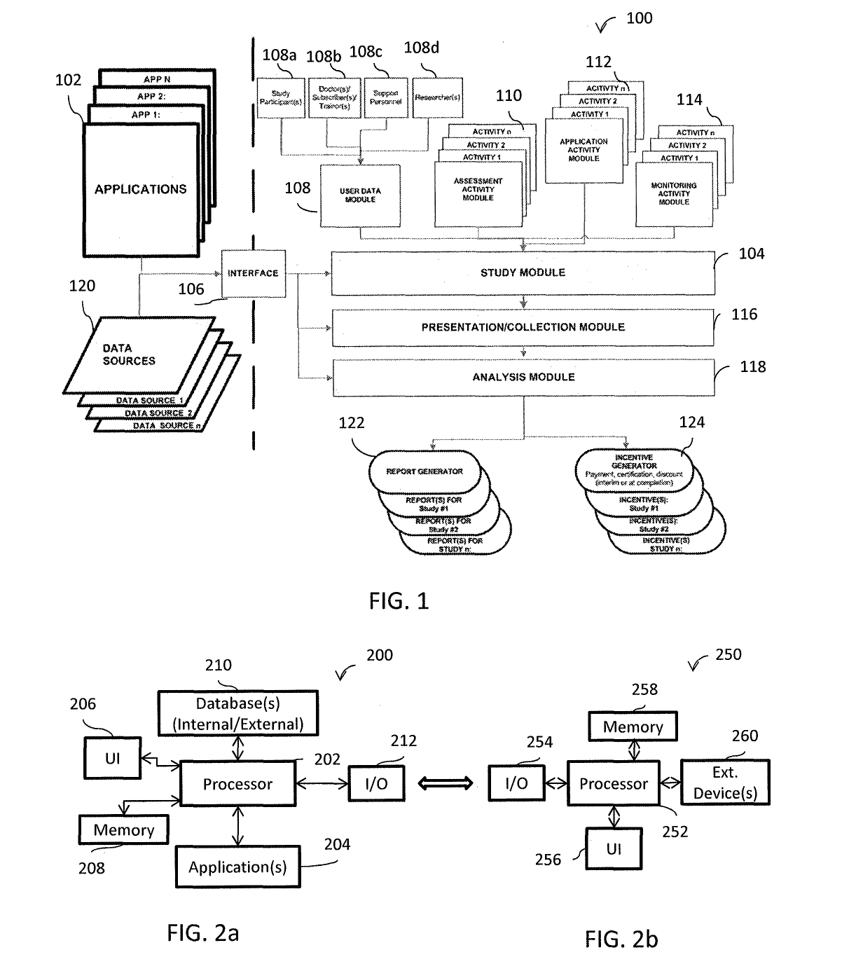

FIG. 1 depicts an exemplary system 100 for assessing applications 102 to evaluate user experience and/or to determine their safety, effectiveness, and/or efficiency. Embodiments of the system are modular in nature and based on the use of standard communication protocols and well-defined Application Programming Interfaces (APIs) in order to provide flexibility and extensibility. As used herein, the term “application” refers to computer applications designed for use by one or more study participants (individually or in groups) to modify user performance to achieve a goal (e.g., desired result). Performance may be modified by, for example, teaching a new skill(s) or changing behavior(s). Goals may be, for example, learning a new skill (e.g., learn a new language or business or clinical procedure or protocol), encouraging behavior beneficial to the user and/or the user's community (e.g., washing hands to reduce infection or tracking and encouraging medication adherence), and discouraging behavior detrimental to the user and/or the user's community (e.g., smoking). Such applications may reside locally on the participant's computer (e.g., desktop, laptop and/or mobile device), may reside on a computer system remote to the user that is accessed via a network (e.g., the Internet), or may include portions that reside locally and portions that reside remotely. Applications may include algorithms or activities that involve multiple elements such as a graphical user interface and/or collection of, monitoring of, or acting on data from a remote monitoring device or sensor or a database. The application may be delivered as a service over a network such as the Internet (commonly referred to as “cloud computing”). As used herein, the term “effectiveness” refers to how well and/or how efficiently an application achieves its goal, and/or the safety of the application, and/or the quality of the user experience.

Applications may be provided to a study module 104 via an interface 106 such as a network interface, Web service and/or Web portal. Study module 104 may be used to set up a study for each application 102 (or a group of applications) as described herein to determine whether the application 102 (or group of applications) achieve the goal of the application (or group of applications). Study module 104 is coupled to a user data module 108, an assessment activity module 110, an application activity module 112, and a monitoring activity module 114. With the information from these modules 108/110/112/114, a researcher may use the study module to create a study for determining the effectiveness of the application 102.

As used herein, the term “study” refers to the systematic evaluation of the use of an application or a group of applications by one or a group of study participants and of the impact that this use has on, for example, one or more of health, wellness, safety, business outcomes of interest, and/or the efficiency with which these outcomes are achieved. It will be understood by one of skill in the art that conducting such a study involves the selection of a study design matched to the specific question to be addressed regarding impact or efficiency of the application(s), the implementation of this study design via delivery of activities (assessment, application, and/or monitoring), collection of data, and the integration and analysis of the data. “Study design” may include identification of the number of study arms, rules for assignment of study participants to study arms, and the content and sequence of activities within each study arm. For example, each study arm may present different applications or may present a substantially similar application differing only in the number, type, or order of activities, which may be used to determine the effectiveness of different activities of the applications. Study implementation includes delivering activities to participants, instructions to perform and log off-line activities (for example, exercising), and collecting information at the level of individual participants about study participant characteristics, participant use of the application(s), and participant outcomes related to the purpose or goal of the application.

User data module 108 may include information regarding various users and/or subjects of the system. Three general types of users may be supported in accordance with various aspects of the present invention: application users/study participants (individuals or related individuals in groups connected, for example, via a social network), technical and administrative support personnel, and researchers. In an exemplary embodiment, the present invention ensures privacy, security and confidentiality by preventing unauthorized access to user profiles and study details through role-based access control and password-protected information access, while enabling researchers to (1) create relationships among application users (including those connected via a social network); (2) design and implement scientific research protocols; (3) assign and sequence application and assessment activities; (4) establish decision rules for the user experience and incentives (such as payments and certifications; (5) specify subject allocation schema (such as randomization or rule-based assignment); (6) deploy data collection measures and methods (monitoring and other application use data, intake, interim and final assessments); (7) establish links to remote data collection devices (e.g., scales for weight measurements, blood pressure cuffs for blood pressure measurement, and GPS units for driving studies) and external databases (such as electronic health records or insurance claims data); and (8) export, query, and analyze data and create reports. In general, further privacy protection and data confidentiality could be attained by encryption of sensitive data (including user profiles and monitored data) by using reliable encryption algorithms such as Rijndael, Serpent, Twofish and RC6. In addition, user assignment rules can determine who has access to private or confidential data. For example, folders storing identifiable data can be stored behind a firewall with access limited only to those with a need for access and authority. A data crosswalk (i.e., a file that links de-identified “unique ID” to identifiable information) may be stored in a different folder from de-identified data.

The various users/subjects in the illustrated embodiment include patient(s), employee(s) or trainee(s) 108a (referred to herein as study participants), their doctor(s), supervisor(s) or trainer(s) 108b, support personnel 108c, and researcher(s) 108d. The information stored for these users may include identification information, relationships between users, permission levels, etc.

The assessment activity module 110 includes activities used to define measures for determining a study participant's attitudes, knowledge, symptoms and/or behaviors, etc. The assessment activities may be used to assess the effectiveness of the application 102. The assessment activity module 110 stores assessment activities for use by the study module 104 and, optionally, may be used to create new assessment activities.

As used herein, the term “assessment activities” refers to activities specified to be performed by or collected about a study participant in order to gather data regarding a study participant's status (e.g., knowledge, attitudes, symptoms, behaviors) and/or a participant's use of the application. Assessment activities may be part of existing application activities, or may be introduced specifically for the purpose of conducting a study. Exemplary assessment activities include, by way of non-limiting example, completing and receiving results from a machine graded test (percent correct), completing a survey, providing personal characteristics and preferences that will trigger or tailor activities, logging off-line activities, or collection of data from remote monitoring devices (e.g., pill counters, electronic cigarette use devices, remote weight scales). It will be understood by one of skill in the art that the assessment activities may be directly or indirectly related to the “application activities”. For example, an assessment of whether a skill was performed correctly may be directly related to training for that skill. On the other hand, a machine graded assessment of depression symptoms may be indirectly related to one or more activities performed prior to taking the test.

The application activity module 112 includes activities for performance by a study participant that are intended to be performed to achieve the goal of the application 102. The application activities include the activities of the application 102 being assessed. The application activity module 112 stores application activities for use by the study module and, optionally, may be used to create new application activities.

As used herein, the term “application activities” is used to refer to tasks specified by an application to be performed by a study participant with the aim of achieving, for example, a health, wellness, and/or safety goal such as a behavioral goal (e.g., to learn, practice, persuade/motivate, correct, support). Such application activities may include, for example, completing tutorials, participating in an online group activity, playing interactive games, completing self-assessments, tracking off-line activities, reading text or viewing videos) or may include assignment of and/or logging of an off-line activity (e.g., exercising or eating healthy foods). Exemplary activities associated with their goals include, by way of non-limiting example, reading a text-based lesson designed to teach a new safety or compliance policy, watching a video designed to motivate parents to stop smoking, receiving and following prompts designed to improve adherence to a prescribed schedule for medications, practicing a skill, such as cardiopulmonary resuscitation, in order to gain proficiency, applying new knowledge via an interactive activity or game in order to reinforce learning, or setting/receiving incentives for positive emotions with the aim of treating depression. Exemplary off-line activities associated with their goals include, assigning participants to exercise 30 minutes per day to improve endurance or assigning telephone or in-person coaching sessions by supervisors to improve employee compliance.

As used herein, the term “application data” refers to the metrics captured that are related to the application activities and the term “assessment data” refers to the metrics captured that are related to the assessment activities. Examples of application data include, for example, whether and how much of a video lesson was watched/not watched, whether and how much of a written lesson was read/not read, whether a simulated Web-delivered skill test was completed/not completed (and the associated score), whether an observed skill test was completed/not completed (and the associated score, e.g., based on feedback from sensors), etc.

The monitoring activity module 114 includes activities for monitoring direct interaction of the study participant with the application and navigation of the application. Additionally, the monitoring activity module may include activities for monitoring parameters associated with the study participant other than the direct interaction by the study participant with the application. For example, monitoring activities may include monitoring heart rate/blood pressure of the study participant throughout the day and/or monitoring the weight of the study participant at periodic intervals (e.g., once per day, etc.). The monitoring activity module stores monitoring activities for use by the study module and, optionally, may be used to create new monitoring activities. In some embodiments, the functionality of the monitoring activity module may be incorporated into the assessment activity module and/or application activity module, in which case the monitoring module may be omitted.

A presentation and collection module 116 is coupled to the study module 104. Study module 104 provides developed studies for applications and associated participant assignment and activity sequencing rules and the presentation and collection module 116 presents the application and assessment activities of the studies to the appropriate study participants for electronic interaction with one or more activities of the application. Additionally, the presentation and collection module 116 collects data from the interaction of the study participants with the application and assessment activities.

An analysis module 118 is coupled to the presentation and collection module 116. The analysis module 118 analyzes data collected by the presentation and collection module 116 to assess the effectiveness of the application. Analysis module 118 may be coupled to a report generator 122 to generate reports for assessing the effectiveness of an application or other reporting needs, for example, regulatory compliance with study procedures. Additionally, analysis module 118 may be coupled to an incentive generator 124 to provide incentives such as payments, certification, discounts, etc. to the study participants.

Remote data sources 120 may be accessed by the study module 104, presentation/collection module 116, and or analysis module 118, e.g., via interface 106. External data sources include information not directly related to the application and assessment activities such as hospital infection rates.

As used herein, the term “remote data sources” refers to on-going and other data collected from a wide range of sources that provide information about the study participant or the study participant's environment or group that may not be specifically collected for a given study. These sources could provide data for explanatory or outcome variables. By way of non-limiting example, these sources can be personal/identifiable clinical remote monitoring devices (e.g., Holter monitors), personal/identifiable data from other sources (e.g., on-line diaries, cellular telephone use, global positioning sensor data collected on handheld devices, laboratory or other tests, electronic health record, insurance or employment records); external databases for non-identifiable group-specific data (medical unit infection and other outcome rates, group compliance rates); or other environmental or publically-available data (e.g., air quality, mortality rates, motor vehicle crash statistics).

Additional details regarding the various modules of FIG. 1 are described below. FIG. 2a depicts an application study development and assessment processing station 200 for use by, for example, researcher(s) and/or administrative/technical staff for developing/modifying applications that are “assessable” and assessing the effectiveness of these assessable applications in accordance with aspects of the present invention. FIG. 2b depicts a study participant station 250 for use by a study participant to interact with the applications from station 200.

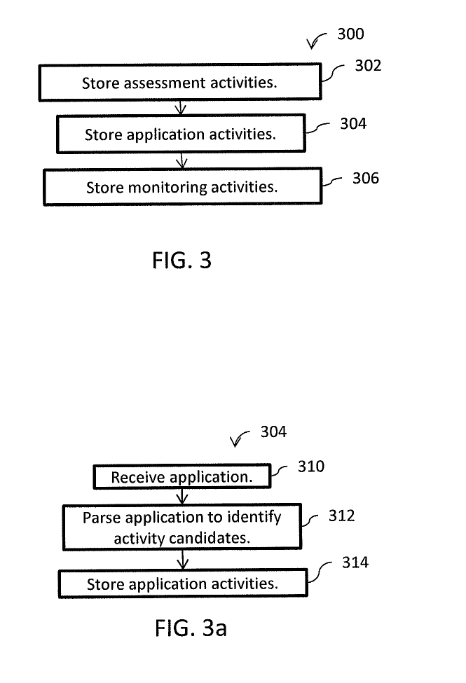

The development and processing station 200 includes a processor 202 for implementing the functionality of one or more of the modules described above with reference to FIG. 1 and/or one or more of the steps described below with referenced to FIGS. 3-6. In particular, processor 202 is configured to develop and/or modify applications 204 in order to present assessable applications to study participants.

Processor 202 is coupled to user interface (UI) 204 for presenting information to and/or receiving information from a user such as a researcher with appropriate security, confidentiality and privacy controls in place. Additionally, processor 202 is coupled to a memory 208. Processor 202 is configured to store information to and/or receive information from memory 208. Suitable processors, user interfaces, and memory will be understood by one of skill in the art from the description herein. Embodiments of the present invention ensure privacy, security and confidentiality by preventing unauthorized access to user profiles and study details through role-based access control and password-protected information access. The present invention may ensure privacy, security and confidentiality by preventing unauthorized access to user profiles and study details through role-based access control and password-protected information access.

Internal and/or external databases 210 are accessible by the processor. Databases 210 may include information described above for data sources 120 (FIG. 1). Processor 202 may present assessable applications to a study participant system 250 (FIG. 2b) via an input/output (I/O) interface 212. I/O interface 212 may be an internal and/or external network connector for passing information via a wired and/or wireless connection.

The study participant station 250 includes a processor 252 for receiving assessable applications presented by the development and processing station 200 (FIG. 2a) for electronic interaction by the study participant. In particular, processor 252 is configured to execute and/or display activities of the assessable applications for electronic interaction by the study participants. Processor 252 may receive assessable applications presented by system 200 (FIG. 2a) via an input/output (I/O) interface 254. I/O interface 254 may be an internal and/or external network connector for passing information via a wired and/or wireless connection.

Processor 252 is coupled to user interface (UI) 256 for presenting information to and/or receiving information from a study participant. The UI 256 enables the study participant to interact with one or more activities of the assessable application and/or with one or more assessment activities. Additionally, processor 252 is coupled to a memory 258. Processor 252 is configured to store information to and/or receive information from memory 258. Suitable processors, user interfaces, and memory will be understood by one of skill in the art from the description herein.

Processor 252 may additionally be coupled (wired and/or wirelessly) to one or more external devices 260, e.g., with appropriate security, confidentiality and privacy controls in place. The external device(s) 260 may be used to collect additional information directly and/or indirectly related to the assessable application. For example, an external device may be a scale for providing weight measurement, a heart rate monitor for providing heart rate during a physical activity of the assessable application, a blood pressure monitor for providing waking blood pressure, etc. For remotely collected data, privacy protection and data confidentiality may be attained by encryption of sensitive data (e.g., user profiles and/or monitored data) using reliable encryption algorithms.

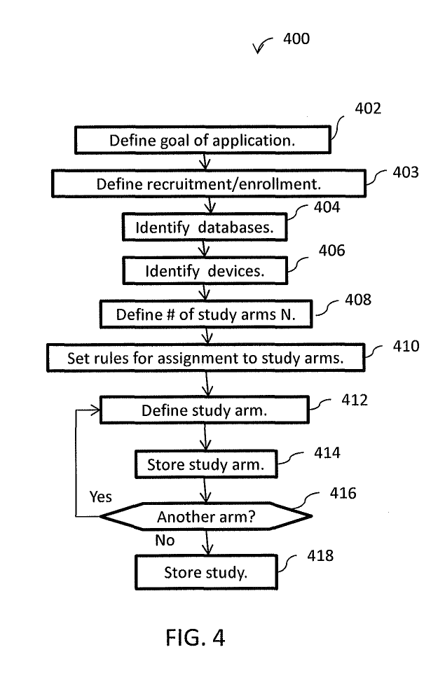

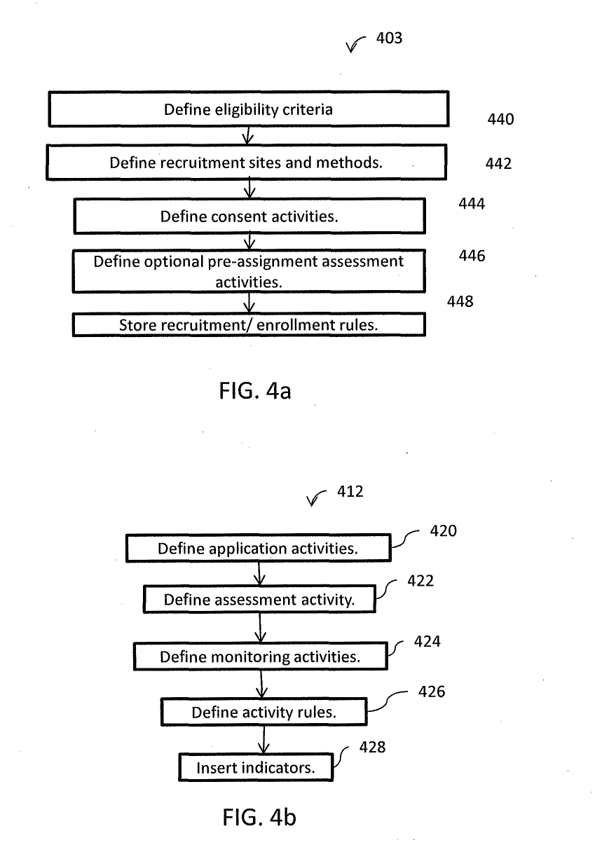

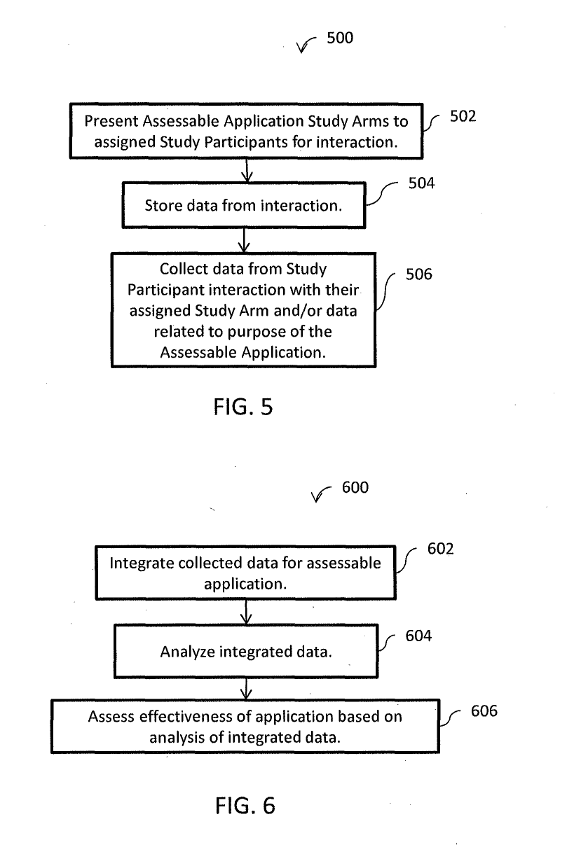

FIGS. 3-6 depict flow charts for storing “libraries” of activities from which studies may be created to assess applications (FIGS. 3 and 3a), for creating studies (FIGS. 4 and 4a), for presenting activities of assessable applications and collecting data (FIG. 5), and for assessing applications (FIG. 6) in accordance with aspects of the invention. The steps of these flow charts are described with reference to the systems 100 and stations 200/250 (FIGS. 1, 2a, and 2b) and the graphical user interfaces (GUIs) 700a-j to facilitate description. Other suitable systems/stations/GUIs will be understood by one of skill in the art from the description herein and are considered within the scope of the present invention.

FIG. 3 depicts a flow chart 300 of steps for creating a “library” of activities from which studies may be created to assess applications.

At block 302, assessment activities are stored. Assessment activities may be generated by processor 202 of station 200 (FIG. 2a) implementing assessment activity module 110 (FIG. 1). A researcher may interact with the processor 202 through user interface 206 to generate one or more assessment activities. The generated assessment activities may be stored in memory 208 by processor 202. Additionally, processor 202 may be used to retrieve an existing assessment activity from memory 208. A researcher may interact with the retrieved assessment activity to modify the assessment activity. The modified assessment activity may be stored in memory in place of the retrieved assessment activity or as another assessment activity.

At block 304, application activities are stored. Application activities may be generated by processor 202 of station 200 (FIG. 2a) implementing application activity module 112 (FIG. 1). A researcher may interact with the processor 202 through user interface 206 to generate one or more application activities. Alternatively, applications may be generated as described below with reference to FIG. 3a. The generated application activities may be stored in memory 208 by processor 202. Additionally, processor 202 may be used to retrieve an existing application activity from memory 208. A researcher may interact with the retrieved application activity to modify the application activity. The modified application activity may be stored in memory in place of the retrieved application activity or as another application activity.

At block 306, monitoring activities are stored. Monitoring activities may be generated by processor 202 of station 200 (FIG. 2a) implementing monitoring activity module 114 (FIG. 1). A researcher may interact with the processor 202 through user interface 206 to generate one or more monitoring activities. The generated monitoring activities may be stored in memory 208 by processor 202. Additionally, processor 202 may be used to retrieve an existing monitoring activity from memory 208. A researcher may interact with the retrieved monitoring activity to modify the monitoring activity. The modified monitoring activity may be stored in memory in place of the retrieved monitoring activity or as another monitoring activity.

FIG. 3a depicts a flow chart of steps for performing the storing of application activities step 304 (FIG. 3) when the application activities are derived from an existing application. At block 310, an application is received. The application may be received by processor 202 implementing the study module 104.

At block 312, the application is parsed to identify activity candidates. In one embodiment, the application is manually parsed by a user to identify activities. In other embodiments, the application may be scanned by processor 202 in a known manner to automatically identify activity candidates, e.g., based on a logical match with stored activity criteria. In yet another embodiment, the application may be automatically scanned to identify preliminary activity candidates from which the user may manually confirm as activity candidates.

At block 314, the activity candidates are stored as application activities. The processor 202 may store one or more of the activity candidates in memory 208 as application activities. A researcher may review the activity candidates and selectively store the activity candidates via the user interface 206.

FIG. 4 depicts a flow chart 400 of steps for creating a study for assessing an application. Those skilled in the art would understand how to extend the embodiments described with reference to FIG. 4 to more complicated study designs that involve comparisons among different applications, different versions of the same application or combinations of applications, or adaptive designs that provide different applications based on rules or triggers. In some embodiments, at one or more steps, the user is presented with a simple graphical user interface, e.g. a drop-down list, menu, or drag-and-drop interface for “easy study set-up” by researchers or technical and administrative support personnel.

At block 402, the goal of the application is defined. In one embodiment, the goal of the application is determined manually by a user. The user may be presented with a list of goals, e.g., via a drop down menu presented by processor 202 via user interface 206, for selection. Exemplary goals include, for example, improving health, decreased infections, improved foreign language skills, etc. In another embodiment, the goal of the application may be determined automatically, e.g., by analyzing the application with the processor. In some embodiments, the goal of the application may not be explicitly defined, in which case this step may be omitted.

At block 403, the rules for recruiting and enrolling participants are defined. In one embodiment, the recruitment sources and methods are defined manually by a user. The user may be presented with a list of recruitment sites and/or enrollment methods, e.g., via a drop down menu presented by processor 202 via user interface 206, for selection. Exemplary recruitment sites or methods include, for example, a panel of patients or employees or open recruitment via a website, etc. In another embodiment, the recruitment method may be determined automatically or by default, e.g., by analyzing the application with the processor. Exemplary enrollment methods include specific regulatory or study-specific inclusion/exclusion criteria and/or other predefined procedures and wording. In some embodiments, the recruitment and enrollment methods or sites may not be explicitly defined, in which case this step may be omitted.

At block 404, one or more databases including information related to the determined purpose of the application and the study are identified. In one embodiment, the databases 210 may be identified manually by a researcher using user interface 206. The researcher may identify the database and the website address for accessing the database. Alternatively, the user may be presented with a list of available databases for selection from which information may be retrieved. Exemplary databases include, for example, employee/student attendance records, department of motor vehicle (DMV) driving records (e.g., accident, citation, suspension information), electronic health or medical record, infection rates for a hospital/region, historical final test information for a language center, etc. In some embodiments, the databases may not be explicitly defined, in which case this step may be omitted.

At block 406, one or more devices that collect data used in conjunction with the application or study related to the determined purpose, are identified. In one embodiment, the devices may be identified manually by a user through user interface 206. The user may identify the devices directly (e.g., through an Internet Protocol address or through manual download of the data from the device) or identify a web location where device data are stored with the website address for accessing the device database. Alternatively, the user may be presented with a list of available devices for selection from which information may be retrieved. Exemplary devices include: electronic pill counters, blood pressure monitors, weight scales or Holter monitors; applications for use on mobile devices; air quality or other environmental monitoring devices; remote hand-washing monitoring stations. In some embodiments, collection of data used in conjunction with the application or study may not be explicitly defined, in which case this step may be omitted.

At block 408, a number of study arms are defined. The number of study arms may be defined by processor 202 in memory 208 based on input received from a researcher via user interface 206. To provide a valid test of the impact of an application (or test relative impact of parts of an application), it may be necessary to compare outcomes achieved in 2 or more groups of study participants—e.g., compare outcomes in those receiving the assessable application (e.g., application activities and monitoring activities) to those receiving no application at all (e.g., only monitoring activities), or compare groups receiving different applications or different versions of the same application. Each of these conditions—in which a group of participants will receive the same things—is referred to herein as a study arm. For each study arm, the researcher defines a specific set of application activities (note: could be defined as no activities at all) to be delivered to study participants and monitoring activities (e.g., assessment or surveys).

A study could include just one arm or condition—in this case all study participants receive the same activities. For example, in a pre-post study, the researcher will compare some relevant score or outcome post-application use to the same thing measured before application use. This type of study could also be used by an organization to monitor the use of an application and its impact over time for quality improvement.

At block 410, rules are set for assigning study participants to study arms. The rules may be set by processor 202 in memory 208 based on input received from a researcher or a researcher-defined rule via user interface 206. For example, if there are two study arms, the rules may be set such that one group of study participants (e.g., employees of a first hospital) receives the activities of a first study arm and another group of study participants (e.g., employees of a second hospital) receives the activities of a second study arm.

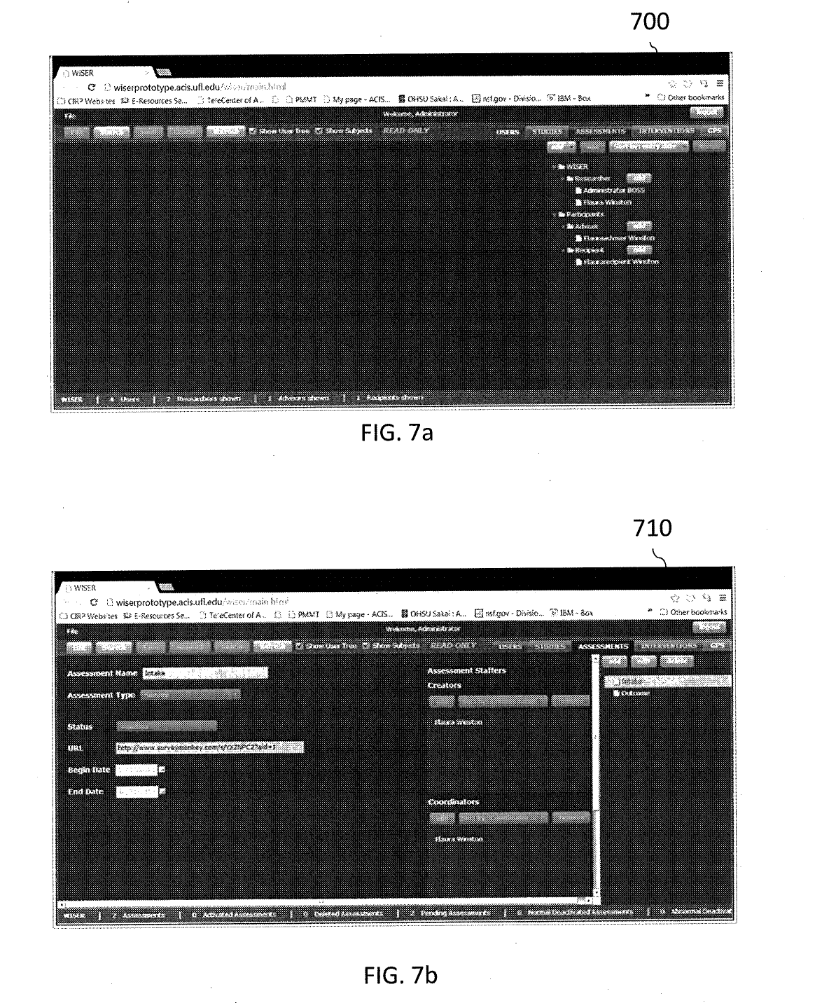

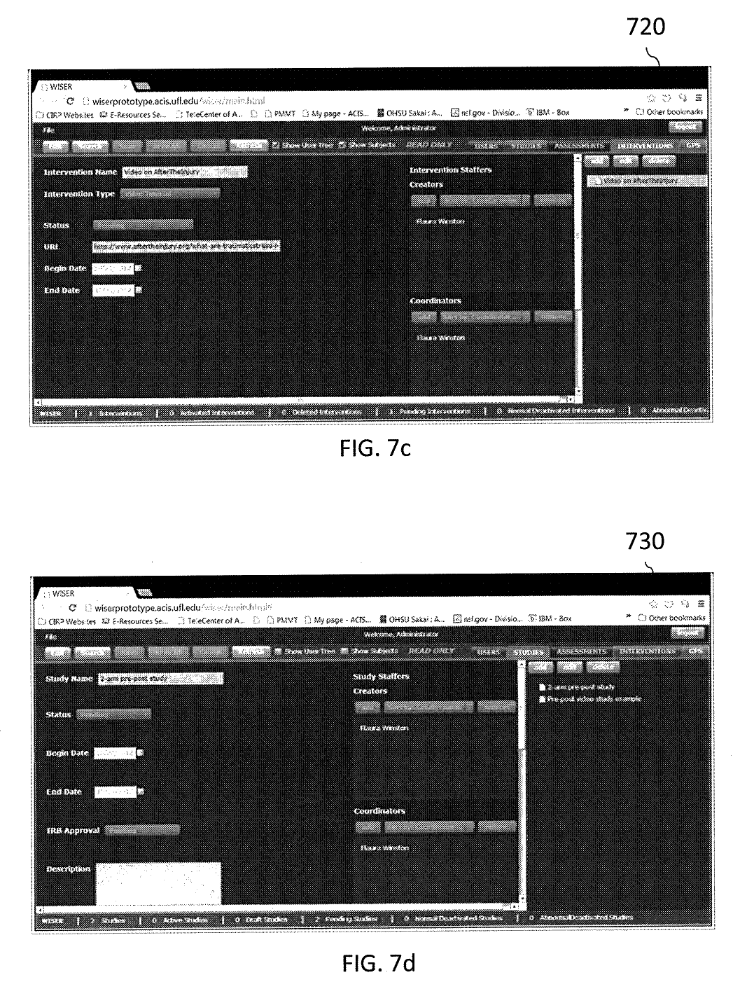

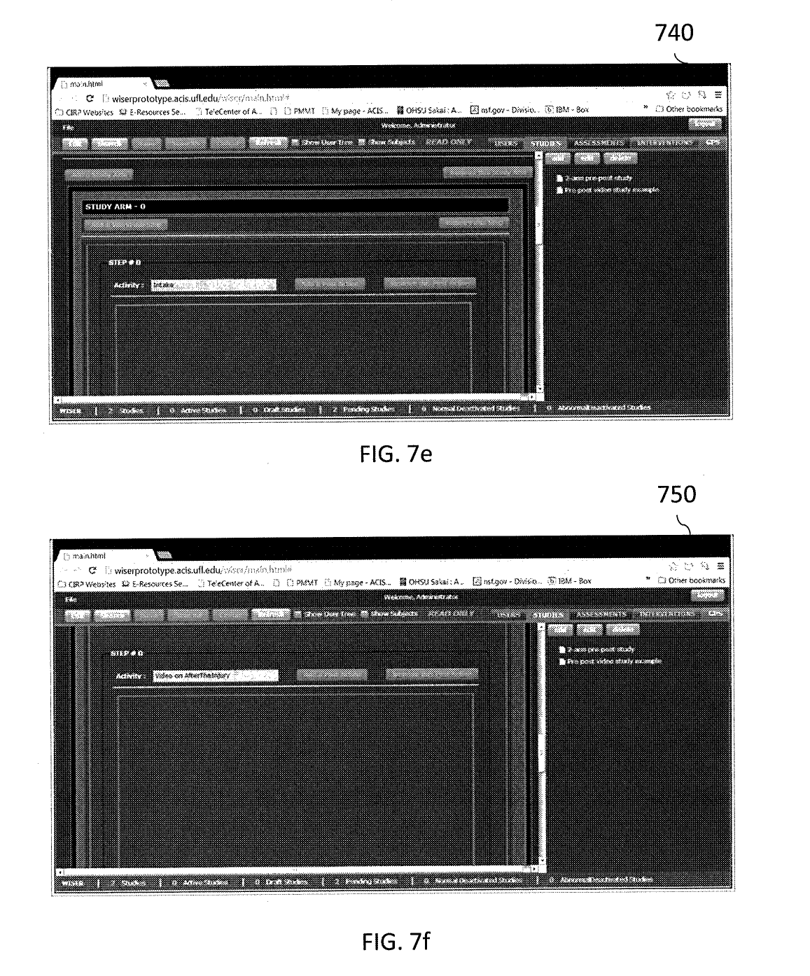

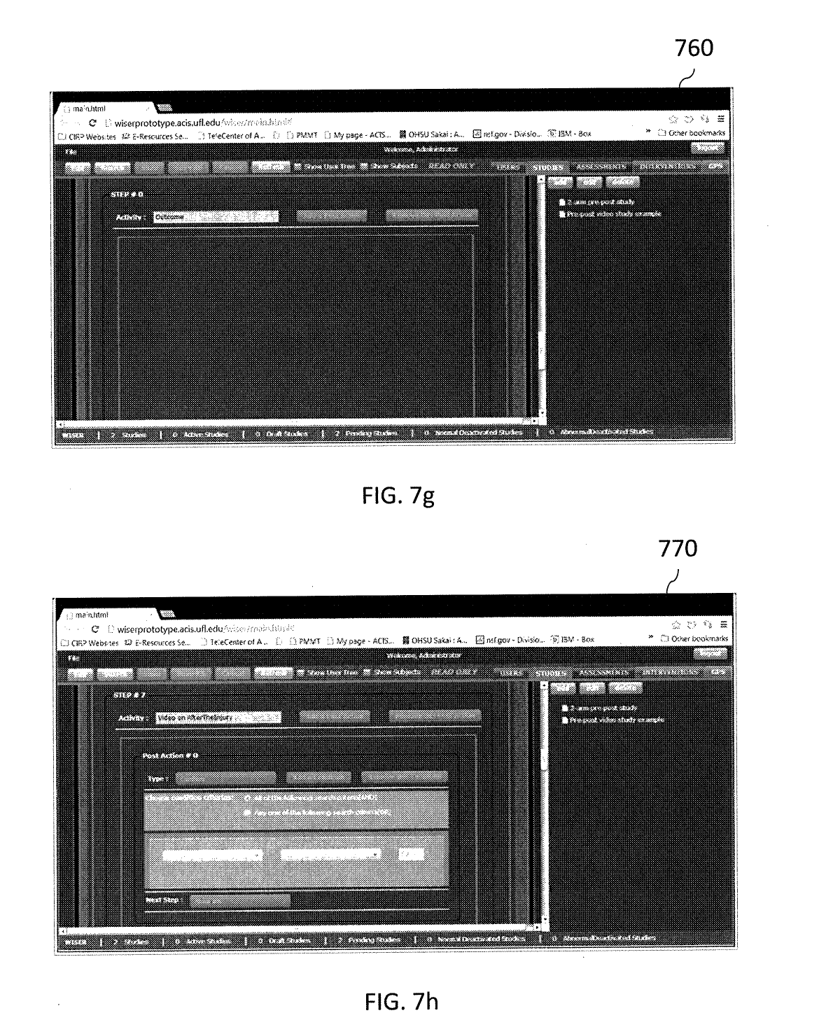

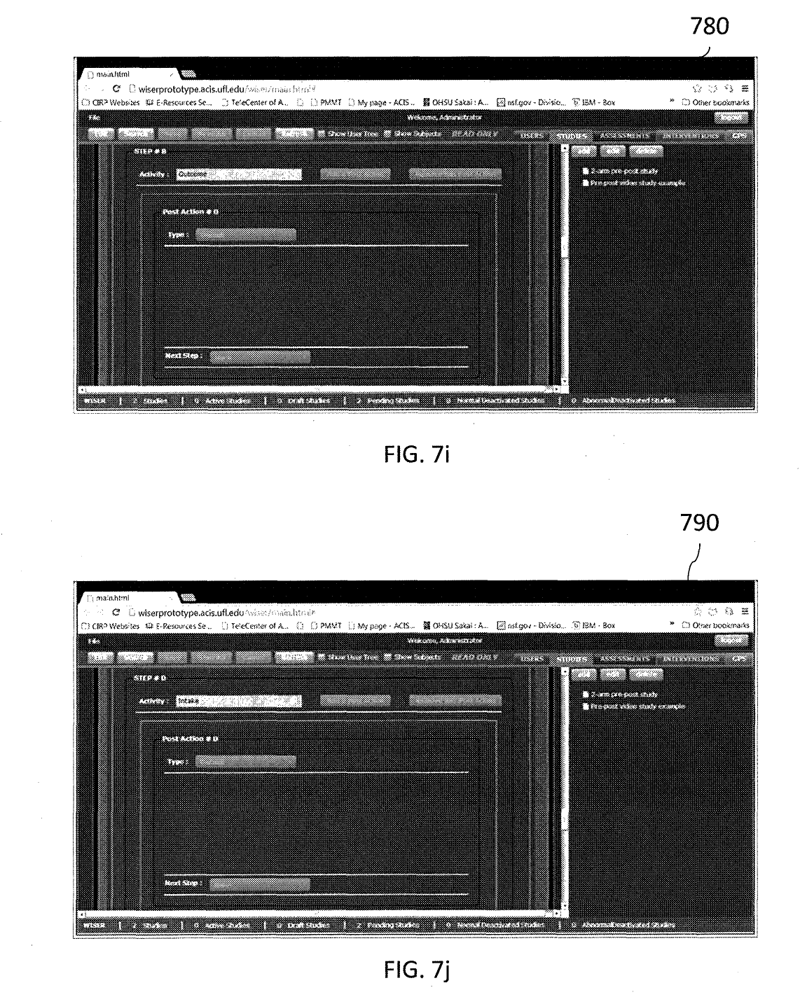

At block 412, a study arm is defined. The study arm may be defined by processor 202 in memory 208 based on input received from a researcher via user interface 206. In some embodiments, the study arm may be defined by the researcher. At least one study arm may be defined based on the application being studied. One or more GUIs may be populated with the results of blocks 302, 304, and/or 306 (FIG. 3), which enables the user to define the activities (application activities, assessment activities, and/or monitoring activities) and set rules for presentation, sequencing and monitoring of application and assessment activities of each study arm by interacting with the GUIs via user interface 106 to select activities. The user selections of activities are then combined to define an assessable application for that arm. Exemplary GUIs are set forth in FIGS. 7a-j and are described in further detail below.

At block 414, the defined study arm is stored. The processor 202 may store the study arm defined at block 412 in memory 208.

At block 416, a system check is performed to determine if all study arms have been defined. The processor 202 may check to determine if all study arms have been defined by comparing a current iteration number of the study to the number of defined study arms. If all of the number of study arms defined at block 406 are defined, processing proceeds at block 418. Otherwise, processing proceeds at block 412 with a second and, if applicable, subsequent study arms being defined.

At block 418, the study is stored. The processor 202 may store all the study arms defined at block 412 in memory 208 as a study.

FIG. 4a depicts a flow chart of steps for defining rules for recruitment/enrollment of block 403 (FIG. 4) in accordance with embodiments of the present invention. At block 440, eligibility criteria for study participants are defined. Examples of eligibility criteria may include inclusion or exclusion criteria based on personal (e.g., age, gender, smoking status) or group (e.g., patients of a physician, company work unit, students in a school) characteristics. The researcher may be presented with a list of standard eligibility criteria, e.g., via a drop down menu, from which the researched selects to define the eligibility criteria.

At block 442, recruitment sites and/or methods are defined. The researcher may identify methods for linking potential subjects to the study to define recruitment methods. Optionally, the researcher may identify a link to an external existing participant pool such as a database of employees or an online participant panel to define recruitment sites.

At block 444, consent activities are defined. For example, to define consent activities the researcher may create a study consent “assessment activity” or identify a link to an external consent activity delivered in person and logged in the system by research staff. The specific wording and procedures for consent may be defined according to regulatory, researcher-defined and other criteria. An exemplary consent activity may include potential participants' completion of an electronic survey that includes items that affirm the participants' agreement to the terms of the study with the inclusion of their electronic signature.

At optional block 446, the researcher may define assessment activities to be delivered before assignment to a study arm. Assessment activities may be delivered prior to assignment to a study arm, for example, in the case where additional information is needed in order to apply a rule for assignment to study arms as defined in block 410.

At block 448, enrollment rules (results of blocks 440, 442, and 444) are stored, e.g., by processor 202 in memory 208.

FIG. 4b depicts a flow chart of steps for defining the study arms of block 412 (FIG. 4). At block 420, application activities are defined. In one embodiment, the processor 202 may present application activities to a researcher via user interface 206 for selection by the researcher from a collection of application activities. The researcher may be presented with a list of application activities, e.g., via a drop down menu, for selection. See, for example, GUI 770 (FIG. 7h). The processor 202 may then define the application activities based on the researcher selections received via the user interface 206. Alternatively, the user may create one or more application activities using tools provided by the system. In embodiments were a goal is defined, a filter may be applied such that only application activities related to the defined goal of the application or study are identified.

At block 422, assessment activities are defined. In one embodiment, the processor 202 may present assessment activities to a researcher via user interface 206 for selection by the researcher from a collection of assessment activities. The researcher may be presented with a list of assessment activities, e.g., via a drop down menu, for selection. See, for example, GUI 780 (FIG. 7i). The processor 202 may then define the assessment activities based on the researcher selections received via the user interface 206. Alternatively, the user may create one or more assessment activities using tools provided by the system. In embodiments where a goal is defined, a filter may be applied such that only assessment activities related with the defined goal of the application or study are identified.

At block 424, monitoring activities are defined. In one embodiment, the processor 202 may present monitoring activities to a researcher via user interface 206 for selection by the researcher from a collection of monitoring activities. The researcher may be presented with a list of monitoring activities, e.g., via a drop down menu, for selection. The processor 202 may then define the monitoring activities based on the researcher selections received via the user interface 206. Alternatively, the user may create one or more monitoring activities using tools provided by the system. In embodiments where a goal is defined, a filter may be applied such that only monitoring activities related with the defined goal of the application or study are identified.

At optional block 426, rules for presenting the application and/or assessment activities are defined. The rules may specify the order and/or conditions under which study participants will be presented with application and assessment activities within each study arm. The researcher may be presented with a list of application and assessment activities from those defined in blocks 420 and 422, e.g., via a drop down menu, for selection. Rules for sequencing may include conditions or branching logic. For example, conditions for presentation of an assessment or application activity could be based on elapsed time, completion of a prior activity, a user's score on a prior assessment activity, and/or other conditions monitored or collected by the system.

At block 428, indicators may be inserted into the assessable application forming the study arm. Processor 202 may insert the indicators automatically and/or under control of a researcher providing instructions via user interface 206. As used herein, the term “indicator” refers to an identifier and/or program code inserted to create an assessable application, which causes capture of data related to an activity specified for performance by a participant, or obtained through external means, such as server calls to an external database. Other suitable methods/techniques for capturing/obtaining data will be understood by one of skill in the art from the description herein, e.g., Web services and server-side data and logs, importation of computer application interaction data provided separately and linked to user data (e.g., via a spreadsheet), or self-reported data provided by users.

In one embodiment, the defining of a study arm includes inserting indicators into the program code associated with the activities of a study arm. The indicators may be manually inserted by manually adding indicators such as program code within the application directing the application to store information for a particular activity (e.g., parameters associated with an assessment directly or indirectly related to an intervention). In a similar manner, the indicators may be manually inserted into the code for the assessment activities for use in monitoring compliance with study procedures. In other embodiments, at least a portion of the indicators may be automatically inserted. For example, predefined program code may be automatically added to the appropriate position within the program code to gather data after an activity.

FIG. 5 depicts a flow chart 500 of steps for presenting assessable applications to study participants and collecting data in accordance with aspects for the present invention.

At block 502, activities for application study arms are presented to the study participants for interaction. In embodiments where rules for assignment to study arm are defined, the study arms are presented based on these assigned rules. Processor 202 may present the activities by accessing the rules for assignment from memory 208 and, then, presenting the activities to the appropriate group of study participants. Processor 202 may present the activities by transferring the activities via I/O interfaces 212/254 to processor 252 of study participant station 250 and/or by causing a GUI to be displayed by study participant station 205 that enables interaction by the study participant with the activities stored at station 200.

At block 504, data from activities are recorded. In embodiments where the study participants, using system 250, interact with activities residing on system 200, processor 202 may record data in memory 208 upon encountering an indicator during execution of the activities defining the study arm. In embodiments where the study participants interact with activities residing on system 250, processor 252 may record data in memory 258 upon encountering an indicator during execution of the activities defining the study arm and subsequently pass the data recorded in memory 258 to processor 202 of system 200 via I/O interfaces 212/254 for storage in memory 208.

At block 506, data is collected from study participant interaction with their assigned study arm assessable application and/or data related to the goal of the assessable application. The data recorded for the application performed by multiple participants may be collected by a processing station for assessment of the application, e.g., to determine whether the application has achieved its intended goals.

In embodiments where the study participants, using system 250, interact with activities residing on system 200, processor 202 may collect the data recorded in memory 208 for all study participants. In embodiments where the study participants interact with activities residing on system 250, processor 252 may retrieve the data recorded in memory 258 via I/O interfaces 212/254 for storage in memory 208.

FIG. 6 depicts a flow chart 600 of steps for assessing the effectiveness of an application.

At block 602, data collected for the assessable applications is integrated. Information from one or more databases or devices related to the goal of the application or study, and information collected from application activities, assessment activities, monitoring activities and/or other sources is integrated. Processor 202 may integrate the data by combining all related information into one or more electronic files such as a flat file (e.g., after linkage through the user id) in memory 208. For privacy, confidentiality and security, processor 202 may post-process the file (e.g., through de-identification) before making information within the file available to the researcher(s).

At block 604, the integrated data are analyzed. The data may be analyzed manually via user interface 206 by viewing the integrated electronic files. The data may also be analyzed automatically using known automated data analysis techniques.

At block 606, the effectiveness of the application is assessed. The effectiveness may be assessed manually based on the analyzed integrated data. The data may also be analyzed automatically, e.g., by comparison to previously defined parameters indicative of success or failure or degrees thereof.

As a non-limiting example, a manager, trainer or medical administrator (“researcher”) wants to evaluate an application to determine whether use of the application improves an employee, student or patient health, safety or wellness outcome. The “researcher” chooses two applications to study in order to choose which has greater impact on the outcome of interest and which achieves outcomes most efficiently. The researcher identifies a randomized controlled trial with two arms as the appropriate study design. The researcher would use the GUIs described herein to set up a two-arm study in which Application A (delivered in Arm 1) is compared to Application B (delivered in Arm 2), with random assignment of participants to study arms. Participants could be recruited from an online panel, consented and enrolled in the study. At the time of enrollment, each participant is randomly assigned to Arm 1 or Arm 2, and then the appropriate application and assessment activities are delivered to each participant. For both groups, data for individual study participants are collected and linked with individual participant data from intake surveys and baseline physiological data, interim and outcome data collected continually (e.g., from external physiological and biological devices) or at multiple time points (e.g., from examinations by medical staff and participant self-assessments), and with health and work-related databases. The data are collected securely, with confidentiality and privacy safeguards in place, integrated at the individual participant level and de-identified, if necessary. The “researcher” receives the integrated data from the system and conducts analyses to see which application, Application A or Application B, achieved the better outcome. Monitoring data is helpful to explain the results (e.g., low usage might suggest that the application was not sufficiently engaging) and would help to measure efficiency (e.g., by providing information on the cost to the participant in terms of time spent using the application).

With this example of a two-arm randomized controlled trial, a typical application is described for each of four domains (education, medical, automotive, environmental).

| DOMAIN | | | | |
|---|---|---|---|---|
| TYPICAL | | | | |
| APPLICATION | Education | | | |
| and STUDY | and | | | |
| INFORMATION | Training | Medical | Automotive | Environmental |
| Typical | Teach new | Improve diabetes | Reduce | Reduce |
| application | business | medication | speeding in | smoking |
| goal | procedure | compliance | designated | among a group |
| | | | high risk areas | of workers |
| Application | App A: | App A: Monitor pill | App A: | App A: |
| types | Online | use with a remote | Remotely | Remotely |
| | lectures | pill counter and | monitor traffic | monitor air |
| | App B: | provide online | patterns and | quality outside |
| | Game | feedback | provide in- | building |
| | | App B: Provide | vehicle | entrances and |
| | | timed reminders | alerts/warnings | post to intranet |
| | | through cellular | App B: | site |
| | | telephone | Remotely | App B: Target |
| | | | monitor user | smokers with |
| | | | driver behavior | online coaching |
| | | | and provide | and provide |
| | | | feedback by | incentives for |
| | | | manager | non-smoking |
| Study Goal | Determine | Determine whether | Determine | Determine |
| | whether | App A or App B | whether App A | whether App A |
| | App A or | produces improved | or App B | or App B |
| | App B | clinical outcomes | results in less | results in group |
| | produces | (e.g., glucose | crashes or | differences in |
| | better | level, Hemoglobin | violations | self-reported |
| | compliance | A1C) and less | among the | smoking and |
| | rates as | missed workdays | participants at | laboratory- |
| | measured | over a 6 month | 1 year | based |
| | by manual | period | | measurement |
| | audits that | | | of biomarkers |
| | are entered | | | |
| | into a | | | |
| | database at | | | |
| | 1 month | | | |

In an exemplary embodiment, one or more of the systems described herein may run at least substantially autonomously when deployed on a large scale—multiple evaluation studies running simultaneously on diverse applications with a large population of application users.

Graphical user interfaces (GUIs) in accordance with aspects of the present invention are depicted in FIGS. 7a-j. The collective GUIs illustrate setting up a study with two study arms. In a first arm, Arm 1 (application group), study participants are asked to: (1) complete an intake survey, i.e., assessment activity; (2) watch a video that is embedded within an existing website, i.e., an application activity; and (3) complete an outcome survey, i.e., another assessment activity. In a second arm, Arm 2 (control group), study participants are only asked to (1) complete an intake survey and (2) complete an outcome survey. Thus, the second arm only completes assessment activities and no application activities. Note: other types of application and assessment activities are allowed but for ease of explanation, the simplest study design is illustrated. In the illustrated embodiment, there are four modules: user, assessment, application, and study setup.

FIG. 7a is a GUI 700 for the user module. There are three categories of users permitted in this embodiment: (1) administration/technical staff, (2) researchers and research staff, and (3) study participants. The system may allow for multiple mechanisms for creating accounts—manual entry, bulk upload or authentication through other services (e.g., through Facebook). Relationships can be created among the users as well as access rules. In GUI 700, one researcher and two study participants are connected to the study. The two study participants are related to each other in the system.

FIG. 7b is a GUI 710 for the assessment module. Through the assessment module, researchers can set up a range of mechanisms for the collection of data about the study participants. There is no obvious limit to the data that can be collected as long as the data stream is made compatible with the system. Currently, the types of data are: bulk upload, link to a database, device data, survey data, custom data, and manual entry. A separate tracking module monitors the study participants' progression through to completion of all study procedures. GUI 710 illustrates a set up in which data are collected through a remotely administered survey.

FIG. 7c is a GUI 720 for the application module (also referred to as intervention module, in the embodiment illustrated in this GUI). Through the intervention module, researchers can set up a range of interventions or portions of existing interventions that they want to study. The intervention module allows for online and/or mobile interaction as well as collection of data about off-line interventions. In one embodiment, a research can choose the intervention under study to be an entire website or portions of the website (e.g., a video, a text segment, a pdf) or design a custom intervention. GUI 720 illustrates a specific video for study that exists on the AfterTheInjury.org website.

FIGS. 7d-7i are GUIs 730/740/750/760/770/780/790 for the study module. Once all of the components of the study are assembled—users, assessments and interventions (i.e., application activities)—the study setup module allows the researcher to set up the study: the specification of name, lifetime (start date and end date), status, eligibility rules, consent questions and assignment rules such as random and manual assignment. Once a study is created, study participation may be verified based on the questions about eligibility and consent and then assigned to a study arm according to the assignment rules, and the assignment of: study staff to the study, the number of arms in the study, the workflow of assessments and interventions that will occur in each arm and the assignment of study participants to each arm. Additional modules implement other aspects of conducting a study, including but not limited to: administering the study, providing technical assistance, tracking the progress of participants through the study workflow steps, collecting and delivering data, managing regulatory aspects of studies and providing subjects with incentives and compensation for study participation.

In the GUIs depicted in FIGS. 7d-i, a simple 2-arm study is set up in which participants in one arm of the study (i.e., the intervention group) will receive an intake assessment, will be sent to view a video intervention and will receive an outcome assessment; in the second arm (i.e., the control group), the participants only received the intake and outcome assessments with no intervention. The Study Module allows researchers to set up number of arms and the workflow within each arm (the order and conditions under which study participants will receive assessments and interventions) and can assign study participants to arms of a study either manually or through randomization schemes.

For Arm 1, Workflow Step 2 (shown as Study Arm #3, Step #7—which is an application activity), a CONDITION is set, Score >50. When this occurs, NEXT STEP is Step #8 (which is an assessment activity).

For Arm 1, Workflow Step 3 (shown as Study Arm #3, Step #8), DEFAULT is selected and there is no NEXT STEP—indicating the conclusion of the study workflow for this arm.

FIG. 7j illustrates one assessment activity in a second study arm—only taking the “INTAKE” survey. The second study arm may be used for a control group, for example.

Although the invention is illustrated and described herein with reference to specific embodiments, the invention is not intended to be limited to the details shown. Rather, various modifications may be made in the details within the scope and range of equivalents of the claims and without departing from the invention.

1. A method for creating studies to assess the effectiveness of computer applications, the method comprising the steps of:
storing a plurality of application activities and assessment activities in a database;
defining, by a processor, a number of study arms of a study for assessing a computer application;
defining, by the processor, each of the number of study arms by receiving selections of at least two of the plurality of application activities and at least one of the plurality of assessment activities from the database for each study arm;
enabling selection, by the processor, of the order and conditions under which the at least one of the plurality of assessment activities and the at least two of the plurality of application activities will be delivered in each study arm independent from an assessment of a participant in the study; and
storing the defined study arms as the study for assessing the effectiveness of the computer application.

2. The method of claim 1, further comprising the steps of:
setting rules for assignment of study participants or groups of study participants to one of the number of study arms;
presenting the study to study participants for electronic interaction.

3. The method of claim 1, wherein the storing of the plurality of application activities and assessment activities in the database comprises:
parsing the computer application to identify candidate application activities; and
storing at least one of the candidate application activities as at least two of the plurality of application activities.

4. (canceled)

5. The method of claim 1, wherein a researcher creates the study and study participants interact with the application and assessment activities of the study arms and wherein the method further comprises:
defining permission levels for each of the researcher and study participants.

6. A system for creating studies to assess the effectiveness of computer applications, the system comprising:
an assessment module configured to store a plurality of assessment activities;
an application module configured to store a plurality of application activities; and
a study module coupled to the assessment module and the application module, the study module configured to create a study including a number of study arms to assess the effectiveness of a computer application by enabling selection, by a user, of at least one of the stored plurality of assessment activities, at least two of the stored plurality of application activities and the order and conditions under which the at least one of the plurality of assessment activities and at least two of the plurality of application activities will be delivered within each study arm.

7. (canceled)

8. The system of claim 6, wherein the study module further enables setting rules for assignment of study participants to each of the number of study arms.

9. The system of claim 8, the system further comprising:
a presentation and collection module coupled to the study module, the presentation and collection module configured to present the study arms to the study participants based on the set rules for assignment and to collect data based on electronic interaction of the study participants and the number of study arms.

10. The system of claim 9, the system further comprising:
an analysis module coupled to the presentation and collection module, the analysis module configured to analyze the collected data to determine the effectiveness of the computer application.

11. The system of claim 10, wherein the analysis module is coupled to an external database to receive external data for use in determining the effectiveness of the computer application.

12. The system of claim 6, wherein the study module further enables defining an order and conditions under which the selected at least two of the plurality of application activities and the selected at least one of the plurality of assessment activities will be presented within each study arm.

13. A method for assessing the effectiveness of computer applications, the method comprising the steps of:
defining application activities corresponding to a computer application for achieving a goal;
defining at least one assessment activity corresponding to the goal;
presenting the defined application activities and at least one assessment activity to a first group of study participants for electronic interaction;
collecting application interaction data from at least one of the defined application activities;
collecting assessment data from the electronic interaction of the first group of study participants with the defined at least one assessment activity at a computer; and
analyzing the collected application interaction data and assessment data with the computer to determine the effectiveness of the computer application at achieving the goal.

14. The method of claim 13, further comprising the step of:
collecting external data related to the goal; and
wherein the analyzing step further comprises analyzing the collected external data to determine the effectiveness of the computer application at achieving the goal.

15. The method of claim 13, wherein the defining of the at least one assessment activity step comprises:
receiving user assessment selection of at least one predefined assessment activity; and
assembling the at least one assessment activity from the selected at least one predefined assessment activity.

16. The method of claim 13, wherein the defining of the application activities comprises:
receiving user application selection of at least one predefined application activity; and
assembling the at least one assessment activity from the selected at least one predefined assessment activity.

17. The method of claim 16, further comprising:
parsing an existing computer application to identify candidate application activities; and
storing the candidate application activities as the at least one predefined application activity.

18. The method of claim 16, further comprising:
receiving user input information defining at least one new application activity; and
storing the at least one new application as the at least one predefined application activity.

19. The method of claim 13, wherein the presented defined application activities and at least one assessment activity form one arm of a study and wherein the method further comprises:
forming at least one other arm of the study, the at least other arm including a variation of the defined application activities; and
presenting the at least one other arm to a second group of study participants for electronic interaction; and
collecting assessment data from the electronic interaction of the second group of study participants with the at least one other study arm;
wherein the analyzing step analyzes the collected assessment data from the first and second groups of study participants to determine the effectiveness of the computer application at achieving the goal.

20. The method of claim 13, wherein the presenting step comprises:
distributing at least one of the application activities to at least one participant of the first group of study participants over a network.

21. The method of claim 13, further comprising the step of:
defining the order and conditions under which the application activities and the at least one assessment activity will be presented within each study arm;
wherein the presenting step further comprises presenting the application activities and the at least one assessment activities in accordance with the defined order and conditions.

22. A method for assessing the effectiveness of computer applications, the method comprising the steps of:
defining a first study arm including at least one assessment activity and application activities corresponding to a computer application for achieving a goal and at least one assessment activity corresponding to the goal;
defining a second study arm including the at least one assessment activity and a variation of the application activities of the first study arm;
presenting the first study arm to a first group of study participants and the second study arm to a second group of study participants for electronic interaction;
collecting data with a computer from the electronic interaction of the first and second groups of study participants with the defined at least one assessment activity; and
analyzing the collected data using the computer to determine the effectiveness of the computer application at achieving the goal.

23. The method of claim 22, further comprising:
identifying number of study arms for assessing the computer application;
defining a unique study arm for each of the identified number of study arms.

24. The method of claim 22, wherein the defining the at least one study arm comprises:
defining application activities corresponding to the computer application for achieving a goal;
defining at least one assessment activity corresponding to the goal.

25. The method of claim 24, wherein the defining the at least one assessment activity comprises:
receiving user assessment selection of at least one predefined assessment activity; and
assembling the at least one assessment activity from the selected at least one predefined assessment activity.

26. The method of claim 25, wherein the defining the application activities comprises:
receiving user application selection of at least one predefined application activity; and
assembling the at least one assessment activity from the selected at least one predefined assessment activity.

27. The method of claim 26, further comprising:
parsing an existing computer application to identify candidate application activities; and
storing the candidate application activities as the at least one predefined application activity.

28. The method of claim 26, further comprising:
receiving user input information defining at least one new application activity; and
storing the at least one new application as the at least one predefined application activity.

29. The method of claim 22, wherein:
the step of defining the first study arm further includes defining the order and conditions for presenting the at least one assessment activity and the application activities; and
the step of defining the second study arm further includes defining the order and conditions for presenting the at least one assessment activity and the variation of the application activities;
wherein the presenting step further comprises presenting the application activities and the at least one assessment activity in accordance with the defined order and conditions for each study arm.

30. The method of claim 22, further comprising the step of:
de-identifying study participants prior to analysis to maintain confidentiality.

31. The method of claim 1, further comprising the step of:
enabling selection of a first study arm and a second study arm having the same at least two application activities, wherein the order and conditions of the application activities of the first study arm are different from the second study arm.

32. The method of claim 31, wherein the first study arm and the second study arm have the same at least one assessment activity.

33. The method of claim 1, further comprising the steps of:
enabling selection of at least two of the defined study arms; and
assessing the effectiveness of the computer application by comparatively analyzing data collected from the at least two of the defined study arms.

34. The method of claim 33, wherein the data comprises assessment activity data linked to application activity data of a participant in the study.

35. The method of claim 34, wherein the application activity data further comprises application activity interaction data and application activity tracking data.

36. The system of claim 6, wherein the study module is further configured to enable selection, by a user, of a first study arm and a second study arm having the same at least one assessment activity.

37. The system of claim 6, wherein the study module is further configured to enable selection, by a user, of a first study arm and a second study arm having the same at least two application activities and wherein the order and conditions of the application activities of the first study arm is different from the second study arm.

38. The system of claim 37, further comprising:
a collection module configured to collect data from the first study arm and the second study arm; and
an analysis module configured to comparatively analyze the collected data to assess the effectiveness of the computer application.

39. The system of claim 6, wherein the study module enables selection and enables assignment of a study arm to a participant of the study independent from an assessment of the participant of the study.

40. The system of claim 38, wherein the data comprises assessment activity data linked to application activity data for a participant in the study.
